(19) United States
(12) Patent Application Publication
(10) Pub. No.: US 2024/0262472 A1
(43) Pub. Date: Aug. 8, 2024

(54) Method and device for estimation of a probability of damage caused by the sloshing of a liquid load during an operation of transferring said liquid load between two floating structures

(71) Applicant: GAZTRANSPORT ET TECHNIGAZ, SAINT-REMY-LES-CHEVREUSE (FR)

(72) Inventors: Erwan CORBINEAU, SAINT-REMY-LES-CHEVREUSE (FR); Arnaud DUMAIL, SAINT-REMY-LES-CHEVREUSE (FR); Alaric SIBRA, SAINT-REMY-LES-CHEVREUSE (FR); Florent OUVRARD, SAINT-REMY-LES-CHEVREUSE (FR)

(21) Appl. No.: 18/567,092

(22) PCT Filed: Jun. 9, 2022
(86) PCT No.: PCT/EP2022/065636

§ 371 Date: Dec. 5, 2023

(30) Foreign Application Priority Data
Jun. 15, 2021 (FR) FR2106344

(51) Int. Cl. B63B 79/30; B63B 25/14; B63B 35/44; F17C 6/00

(52) U.S. Cl. CPC B63B 79/30; B63B 25/14; B63B 35/44; F17C 6/00; B63B 2035/448; F17C 2221/033; F17C 2221/035; F17C 2223/0153; F17C 2225/0153; F17C 2250/034; F17C 2250/0408; F17C 2250/0478; F17C 2260/04; F17C 2265/06; F17C 2270/0105

(57) ABSTRACT

The invention relates to a method (300) of estimation of a probability of damage caused by sloshing of a liquid load during an operation to transfer said liquid load from a first floating structure (1) to a second floating structure (40), the first floating structure (1) and the second floating structure (40) being associated with one another during said transfer operation so that the first floating structure (1) and the second floating structure (40) are oriented with a common bearing (99). The method includes steps (307) of estimating a probability of damage to at least one tank of at least one of said first and second floating structures (1, 40) and (308) of supplying information to a user as a function of the probability of damage estimated in this way.

### TECHNICAL FIELD

The invention concerns operations for transferring a liquid load between two floating structures. The invention relates more particularly to a method and to a device for estimation of a probability of damage caused by the sloshing of a liquid load during an operation to transfer said liquid load from a first floating structure to a second floating structure.

### TECHNOLOGICAL BACKGROUND

In the field of floating structures able to transport a liquid load, it is known to proceed to operations to transfer the liquid load from a first floating structure, such as a liquid carrier ship, to a second floating structure.

Operations of this kind of transferring a liquid load are in particular commonly employed for cargoes of liquefied natural gas (LNG). For such cargoes, in known manner, an LNG carrier ship, such as a methane tanker (also known as an LNG carrier (LNGC)) is able to move closer to a floating storage and regasification unit (FSRU) for liquefied natural gas. The FSRU is for example situated offshore and moored to a submarine buoy or to a turret-moored system enabling the structure to be oriented freely because of the forces that are applied to it (by waves, wind, current, etc.). The LNGC is then moored to the FSRU and flexible pipes are installed between the LNGC and the FSRU to transfer the LNG between the LNGC and the FSRU. An LNG transfer operation of this kind, known as a ship-to-ship Transfer (STS), is known in itself. It can also be carried out between an LNGC and another floating structure such as a floating liquid natural gas (FLNG) production unit.

However, during an operation of this type the tanks of the LNGC and of the FSRU intended to contain the LNG are partly filled. It is known that in a situation of this kind the LNG contained in the tanks is agitated by the effect of waves. The agitation of the liquid, generally known as sloshing, generates forces on the walls of the tank that may compromise the integrity of the tank. Now, the integrity of the tank is particularly important in the context of a tank intended to contain LNG because of the inflammable or explosive nature of the liquid transported and the risk of cold spots on the steel hull of the floating structure.

Furthermore, an operation of this type is liable to take a long time, of the order of several tens of hours when it involves an LNGC and a FSRU of high capacity or a floating liquid natural gas (FLNG) production unit. Now, the longer the time necessary for the operation, the greater the risk of climate conditions arising that are liable to cause sloshing of the LNG in the tanks.

In the light of the above, it would be useful to have methods and systems assisting limitation or even elimination of the risk of damage to the tanks caused by sloshing.

### SUMMARY

One idea behind the invention is to make use of meteorological and oceanographic forecasts relating to the geographical location of the liquid load transfer operation for an expected duration of said transfer operation to estimate a probability of damage to at least one tank of at least one of the floating structures involved in the transfer operation. Another idea behind the invention is to provide a user with information as a function of the probability of damage estimated in this way.

In accordance with an embodiment conforming to a first variant the invention provides a method for estimation of a probability of damage caused by sloshing of a liquid load during an operation to transfer said liquid load from a first floating structure to a second floating structure, the first floating structure and the second floating structure being associated with one another during said transfer operation so that the first floating structure and the second floating structure are oriented with a common bearing, said method including:
obtaining a forecast geographical position of said transfer operation;
obtaining meteorological and oceanographic forecasts relating to said geographical position for a plurality of periods of time, said periods of time together covering a forecast duration of said transfer operation, said forecasts including, for each period of time, a swell state, in which the swell state includes a direction of the swell, a significant height of the swell and a period of the swell;
for each period of time: obtaining the common bearing of the first and second floating structures; determining at least one forecast filling level of at least one tank of at least one of said first or second floating structures intended to contain all or part of said liquid load; determining an angle of attack of the swell, which is an angle between said common bearing of the first and second floating structures and the direction of the swell; and estimating at least one probability of damage to said at least one tank as a function of the angle of attack of the swell determined in this way, of the significant height of the swell, of the period of the swell and of the forecast filling level of said tank; and
supplying information to a user as a function of said at least one probability of damage estimated in this way.

Thanks to a method of this kind a user such as a crew member is able to implement any measure necessary to limit the risk of damage to the tanks of the floating structure or structures, such as for example modifying the bearing common to the two floating structures and/or modifying a parameter of the transfer operation, for example a liquid load transfer flowrate (between the tanks of the same floating structure and/or between the tanks of the two floating structures) and/or a filling level of the tank or tanks.

Embodiments of a method of this kind may have one or more of the following features.

In accordance with one embodiment the period of the swell is a peak period of the swell, that is to say a period of time between the passage of two successive peaks of the swell. In accordance with one embodiment the period of the swell is mean period of the swell, that is to say a period of time between three passages of the swell at the mean height of the sea; this period is commonly denoted T_{z}.

The forecast filling level of the tank can be estimated in various ways. In accordance with one embodiment said at least one forecast filling level is determined from a liquid load transfer scenario defining an evolution of the filling level of said tank as a function of time.

A liquid load transfer scenario of this kind may in particular be entered by the user at the start of the transfer operation.

In accordance with one embodiment, for each period of time, two forecast filling levels of said tank are determined, the two forecast filling levels including a low forecast filling level and a high forecast filling level, and a probability of damage to said tank is estimated for each of the two forecast filling levels.

In this way the estimate of the probability of damage can take account of the fact that the sloshing of the liquid load is different depending on the level of filling of the tank.

In accordance with one embodiment the low forecast filling level and the high forecast filling level are determined in advance during a preliminary step consisting in looking, for example by simulation and/or by experiment, for two levels of filling of the tank that are the most likely to result in a risk of damage to the tank caused by sloshing.

The probability of damage can be estimated in various ways. In accordance with one embodiment the probability of damage is estimated by consultation of a database established beforehand for said tank, said database including data relating to sloshing as a function of an angle of attack of the swell, of a significant height of the swell, of the period the swell and of a current filling level of said tank,
the data relating to sloshing being determined by experiment, and
the probability of damage being related to a density of probability of encountering a pressure on an internal surface of the tank above an internal strength of the tank as a function of the angle of attack of the swell, of the significant height of the swell, of the period of the swell and of the current filling level of said tank.

In accordance with one embodiment said information includes information representing the probability of damage estimated as a function of said periods of time. In particular, in accordance with one embodiment said information includes a visual indication of the probability of damage estimated as a function of said periods of time.

In accordance with one embodiment the first floating structure and the second floating structure are anchored to an anchor point during said transfer operation.

In accordance with one embodiment said forecasts further include a wind sea state, the wind sea state including a significant wind sea height and/or a wind sea period and/or a wind sea direction.

In accordance with one embodiment the wind sea period is a peak wind sea period, that is to say a period of time between the passage of two successive peaks of the wind sea. In accordance with one embodiment the period of the swell is a mean period of the wind sea, that is to say a period of time between three successive passages of the wind sea at the mean height of the sea; this mean period is commonly denoted T_{z}.

In accordance with one embodiment the probability of damage to said at least one tank is further estimated as a function of the wind sea state.

The common bearing of the first and the second floating structures can simply be supplied in advance for each period of time, for example by the user. Alternatively, in accordance with one embodiment, for each period of time, said common bearing of the two floating structures is obtained by:
calculating, for a plurality of theoretical bearings, a resultant of the forces to which the first and second floating structures are subjected as a function of the swell state and of a moment relative to the anchor point of said resultant;
selecting from said plurality of theoretical bearings a common bearing that minimizes the absolute value of the moment relative to the anchor point of said resultant.

In accordance with one embodiment the resultant of the forces to which the first and second floating structures are subjected is further calculated as a function of the wind sea state.

In accordance with one embodiment said forecasts further include a wind state including a speed of the wind and/or a direction of the wind and the resultant of the forces to which the first and second floating structures are subjected is further calculated as function of the wind state.

In accordance with one embodiment said forecasts further include a current state, the current state including a speed of the current and/or a direction of the current, and in which the resultant of the forces to which the first and second floating structures are subjected is further calculated as a function of the current state.

In accordance with one embodiment said information includes information representing the probability of damage estimated as a function of said plurality of theoretical bearings.

In accordance with one embodiment the method further included a step of assisting the decision intended to reduce the estimated probability of damage.

In accordance with one embodiment the step of assisting the decision includes supplying to the user:
a proposal to change the common bearing, and/or
a proposal to modify at least one parameter of the transfer operation.

In accordance with one embodiment the proposed modification of at least one parameter of the transfer operation includes a proposed modification of a liquid load transfer flowrate (between the tanks of the same floating structure and/or between the tanks of the two floating structures) and/or of a level of filling of the tank or tanks.

Thus the user is rendered capable of implementing the necessary measures on the basis of these proposals in order to reduce the risk of damage to the tanks.

The method is applicable to floating structures transporting any type of liquid load. It nevertheless finds one particular application to floating structures transporting a cold liquid product load.

In accordance with one embodiment the liquid load is a liquefied gas load, in particular a liquefied petroleum gas (LPG) load or a liquefied natural gas (LNG) load.

In accordance with one embodiment the at least one tank is a sealed and/or thermally-insulating tank.

In accordance with one embodiment the first floating structure is a liquefied natural gas carrier (LNGC) ship and the second floating structure is a liquefied natural gas floating storage and regasification unit (FSRU) or a floating liquefied natural gas (FLNG) production unit.

In accordance with one embodiment the invention also provides a device for estimation of a probability of damage caused by sloshing of a liquid load during an operation to transfer said liquid load from a first floating structure to a second floating structure, the first floating structure and the second floating structure being associated with one another during said transfer operation so that the first floating structure and the second floating structure are oriented with a common bearing, the device including a processor configured to execute any one of the above embodiments of the method.

A device of this kind has the same advantages as those described above with reference to the method.

In accordance with one embodiment the invention also provides a floating structure including a device as described hereinabove.

The principles described hereinabove are equally applicable to a floating structure transporting a liquid load and anchored to an anchor point. Indeed, the liquid load of a floating structure of this kind is also liable to be agitated by the effect of waves, which can also lead to a phenomenon of sloshing that is liable to compromise the integrity of the tank or tanks containing the liquid load.

Accordingly, in accordance with an embodiment conforming to a second variant, the invention provides a method for estimation of a probability of damage caused by the sloshing of a liquid load of a floating structure, the floating structure being moored to an anchor point relative to the seabed whilst being free to pivot about said anchor point, said method including:
obtaining a geographical position of the floating structure moored to the anchor point;
obtaining meteorological and oceanographic forecasts relating to said geographical position for a plurality of periods of time, said forecasts including for each period of time a swell state that includes a direction of the swell, a significant height of the swell and a period of the swell;
for each period of time: obtaining a bearing of the floating structure: determining at least one forecast level of filling of at least one tank of said floating structure intended to contain said liquid load; determining an angle of attack of the swell, which is an angle between said bearing and the direction of the swell; and estimating at least one probability of damage to said at least one tank as a function of the angle of attack of the swell determined in this way, of the significant height of the swell, of the period of the swell and of the forecast filling level of said tank; and
supplying information to a user as a function of said at least one probability of damage estimated in this way.

Thanks to a method of this kind a user such as a crew member is able to implement any measure necessary to limit the risk of damage to the tank or tanks of the floating structure such as for example modifying the bearing of the floating structure, remembering that the floating structure is free to pivot about its anchor point.

Embodiments of a method of this kind may have one or more of the following features.

In accordance with one embodiment the period of the swell is a peak period of the swell, that is to say a period of time between the passage of two successive peaks of the swell. In accordance with one embodiment the period of the swell is a mean period of the swell, that is to say a period of time between three successive passages at the mean height of the sea; this mean period is commonly denoted T_{z}.

In accordance with one embodiment the probability of damage is estimated by consultation of a database established beforehand for said tank, said database including data relating to sloshing as a function of an angle of attack of the swell, of a significant height of the swell, of the period of the swell and of a current level of filling of said tank, the data relating to the sloshing being determined by experiment, and the probability of damage being relative to a probability density of encountering a pressure on an internal surface of the tank greater than an internal strength of the tank as a function of the angle of attack of the swell, of the significant height of the swell, of the period of the swell and of the current level of filling of said tank.

In accordance with one embodiment said information includes information representing the probability of damage estimated as a function of said periods of time. In particular, in accordance with one embodiment said information includes a visual indication of the probability of damage estimated as a function of said periods of time.

In accordance with one embodiment said forecasts further include a wind sea state, the wind sea state including a significant wind sea height and/or a wind sea period and/or a wind sea direction.

In accordance with one embodiment the wind sea period is a peak wind sea period, that is to say a period of time between the passage of two successive peaks of the wind sea. In accordance with one embodiment the period of the swell is a mean period of the wind sea, that is to say a period of time between three successive passages at the mean height of the sea; this period is commonly denoted T_{z}.

In accordance with one embodiment the probability of damage to said at least one tank is further estimated as a function of the wind sea state.

The bearing of the structure may simply be supplied in advance for each period of time, for example by the user. Alternatively, in one embodiment, for each period of time, said common bearing of the floating structure is obtained by:
calculating for a plurality of theoretical bearings a resultant of the forces to which the floating structure is subjected as a function of the state of the well and a moment relative to the anchor point of said resultant;
selecting from said plurality of theoretical bearings a common bearing that minimizes the absolute value of the moment relative to the anchor point of said resultant.

In accordance with one embodiment the resultant of the forces to which the floating structure is subjected is further calculated as a function of the wind sea state.

In accordance with one embodiment said forecasts further include a wind state including a speed of the wind and/or a direction of the wind and the resultant of the forces to which the floating structure is subjected is further calculated as a function of the wind state.

In accordance with one embodiment said forecasts further include a current state including a speed of the current and/or a direction of the current and the resultant of the forces to which the floating structure is subjected is further calculated as a function of the current state.

In accordance with one embodiment the resultant of the forces to which the floating structure is subjected is further calculated as a function of the wind sea state.

In accordance with one embodiment said forecasts further include a wind state including a speed of the wind and/or a direction of the wind and the resultant of the forces to which the floating structure is subjected is further calculated as a function of the wind state.

In accordance with one embodiment said forecasts further include a current state including a speed of the current and/or a direction of the current and the resultant of the forces to which the floating structure is subjected is further calculated as a function of the current state.

In accordance with one embodiment said information includes information representing the probability of damage estimated as a function of said plurality of theoretical bearings.

In accordance with one embodiment the method further includes a step of assisting the decision intended to reduce the estimated probability of damage.

In accordance with one embodiment the step of assisting the decision includes supplying to the user:
a proposed change of bearing of the floating structure, and/or
a proposed modification of a level of filling of at least one of the tanks of the floating structure.

The user is therefore rendered capable of implementing the necessary measures on the basis of these proposals in order to reduce the risk of damage to the tank or tanks of the floating structure.

The method is applicable to floating structures transporting any type of liquid load. It nevertheless finds a particular application to floating structures transporting a cold liquid product load.

In accordance with one embodiment the liquid load is a liquefied gas load, in particular a liquefied petroleum gas (LPG) load or a liquefied natural gas (LNG) load.

In accordance with one embodiment the at least one tank is a sealed and/or thermally-insulating tank.

In accordance with one embodiment the floating structure is a liquefied natural gas carrier (LNGC), a liquefied natural gas floating storage and regasification unit (FSRU) or a floating liquefied natural gas (FLNG) production unit.

In accordance with one embodiment the invention also provides a device for predicting an estimated probability of damage caused by sloshing of a liquid load of a floating structure moored to an anchor point relative to the seabed and free to pivot about said anchor point, the device including a processor configured to execute any of the embodiments of the method described hereinabove.

A device of this kind has the same advantages as described hereinabove with reference to the method.

In accordance with one embodiment the invention also provides a floating structure including a device as described hereinabove.

### BRIEF DESCRIPTION OF THE FIGURES

The invention will be better understood and other objects, details, features and advantages thereof will become more clearly apparent in the course of the following description of particular embodiments of the invention given by way of non-limiting illustration only and with reference to the appended drawings.

FIG. 1 is a schematic representation in longitudinal section of a floating structure, in this instance a ship, including a plurality of tanks containing a liquid load.

FIG. 2 is a schematic representing two floating structures, in this instance a ship and a floating structure, associated with one another during a liquid load transfer operation and a wind sea state, a swell state, a current state and a wind state to which the two floating structures may be subjected.

FIG. 3A is a flowchart representing a method for estimation of a risk of damage caused by sloshing of a liquid load during an operation to transfer said liquid load from a first floating structure to a second floating structure.

FIG. 3B is a detail of the FIG. 3A flowchart representing a variant of the method.

FIG. 4 represents a device for prediction of the sloshing of a liquid load during an operation to transfer said liquid load from a first floating structure to a second floating structure.

FIG. 5 represents an example of a visual indication of the estimated probability of damage to a tank of a floating structure as a function of periods of time.

FIG. 6 is a schematic representing a floating structure moored to an anchor point relative to the seabed and free to pivot about said anchor point and of a wind sea state, a swell state, a current state and a wind state to which the floating structure may be subjected.

FIG. 7A is a flowchart representing a method for estimation of a risk of damage caused by sloshing of a liquid load of the FIG. 6 floating structure.

FIG. 7B is a detail of the FIG. 7A flowchart representing a variant of the method.

### DESCRIPTION OF EMBODIMENTS

The figures are described hereinafter in the context of a ship 1 including a double hull forming a supporting structure in which are arranged a plurality of sealed and thermally-insulating tanks. A supporting structure of this kind has a polyhedral geometry for example, of prismatic shape for example.

Sealed and thermally-insulating tanks of the above kind are designed for example for the transportation of liquefied gas. The liquefied gas is stored and transported in tanks of the above kind at a low temperature, which necessitates thermally-insulating tank walls in order to maintain the liquefied gas at that temperature. It is therefore particularly important to maintain the integrity of the tank walls intact on the one hand to preserve the seal of the tank and to prevent leaks of liquefied gas out of the tanks and, on the other hand, to prevent deterioration of the insulating characteristics of the tank in order to maintain the gas in its liquefied form.

Sealed and thermally-insulating tanks of the above kind also include an insulating barrier anchored to the double hull of the ship and carrying at least one sealed membrane. By way of example, tanks of this kind may be produced using technologies of Mark III® type as described for example in FR 2 691 520 A1, of NO96® type as described for example in FR 2 877 638 A1, or of other type as described for example in WO 2014/057221 A2.

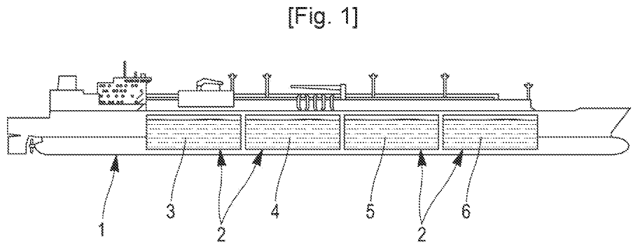

FIG. 1 depicts a ship 1 including four sealed and thermally-insulating tanks 2. On a ship 1 of this kind the tanks 2 are interconnected by a cargo handling system (not depicted) that may include numerous components, for example pumps, valves and pipes, so as to enable the transfer of liquid from one of the tanks 2 to another tank 2.

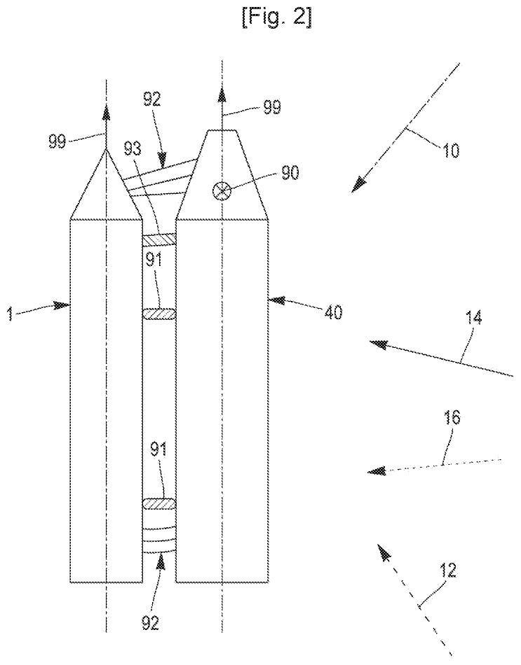

In FIG. 2 the ship 1 has been represented associated with a stationary floating structure 40 in order to carry out a ship-to-ship (STS) operation to transfer the LNG contained in the four tanks 2 of the ship 1 to sealed and thermally-insulating tanks (not represented) of the stationary floating structure 40. Here the stationary floating structure 40 is a floating storage and regasification unit (FSRU) for liquefied natural gas, but it could equally well be a floating liquid natural gas (FLNG) production unit, another LNG carrier ship analogous to the ship 1, or more generally any floating structure, stationary or not, including sealed and thermally-insulating tanks to receive LNG.

Here the stationary floating structure 40 is located offshore and moored to an anchor point 90 relative to the seabed, such as an underwater buoy anchored to the seabed or a turret mooring system. The ship 1 is associated with the stationary floating structure 40 by means of a plurality of mooring lines 92, typically situated at the bow and at the stern of the ship 1 and of the stationary floating structure 40. Floats 91 may be disposed between the stationary floating structure 40 and the ship 1 to prevent any accidental collision between the latter. At least one flexible pipe 93 is installed in order to carry out the transfer of the LNG contained in the four tanks 2 of the ship 1 to the tanks of the stationary floating structure 40.

During the LNG transfer operation the ship 1 and the stationary floating structure are oriented with the same bearing 99, hereinafter referred to as the common bearing 99. It is nevertheless specified that the common bearing 99 may be modified during the transfer operation, which may last several hours or even several tens of hours.

The ship 1 typically arrives in the vicinity of the stationary floating structure 40 with its four tanks 2 almost entirely filled with LNG. However, as the LNG is transferred, the tanks 2 are progressively emptied. In FIG. 1 the four tanks 2 have a partial filling state. A first tank 3 is filled to approximately 60% of its capacity. A second tank 4 is filled to approximately 35% of its capacity. A third tank 5 is filled to approximately 35% of its capacity. A fourth tank 6 is filled to approximately 40% of its capacity.

This partial filling of the tanks 3, 4, 5, 6 can generate high risks of damage to said tanks 3, 4, 5, 6 during the LNG transfer operation. Indeed, when it is at sea the ship 1 is subjected to numerous movements linked to climatic conditions.

In particular, the ship 1 is subjected to wind sea excitation represented by the axis 10, to swell excitation represented by the axis 12, to current excitation 14, and to wind excitation 16. The wind sea is created by the wind excitation 16 in the vicinity of the ship 1 and induces waves having a wind sea direction parallel to the axis 10, a significant wind sea height and a peak wind sea period. The swell is created by wind excitation far from the ship 1 and causes waves having a swell direction parallel to the axis 12, a significant swell height and a peak swell period. The encounter of the waves induced by the swell and by the wind sea causes movements of the ship 1. The ship 1 is also subject to movements caused by the current, the current having a direction parallel to the axis 14 and a current speed. Finally, the ship 1 is subjected to wind excitation, the wind having a direction parallel to the axis 16 and a wind speed. These movements of the ship 1 are transmitted to the liquid contained in the tanks 3, 4, 5, 6 which is consequently subjected to sloshing in the tanks 3, 4, 5, 6, producing impacts on the tank walls. If the sloshing exceeds the capacity of the tank walls to absorb or to disperse the sloshing the impacts on the tank walls 3, 4, 5, 8 can degrade the tank walls 3, 4, 5, 6. Now it is important to preserve the integrity of the tank walls 3, 4, 5, 6 to preserve the seal and the insulation characteristics of the tanks 3, 4, 5, 6. It is therefore important to estimate a probability of damage caused by sloshing in order to prevent such damage.

Obviously, the risk of damage to the tank walls 3, 4, 5, 6 of the ship 1 is equally present for the walls of the tanks of the stationary floating structure 40, which is also subjected to the wind sea excitation 10, the swell excitation 12 and the current excitation 14.

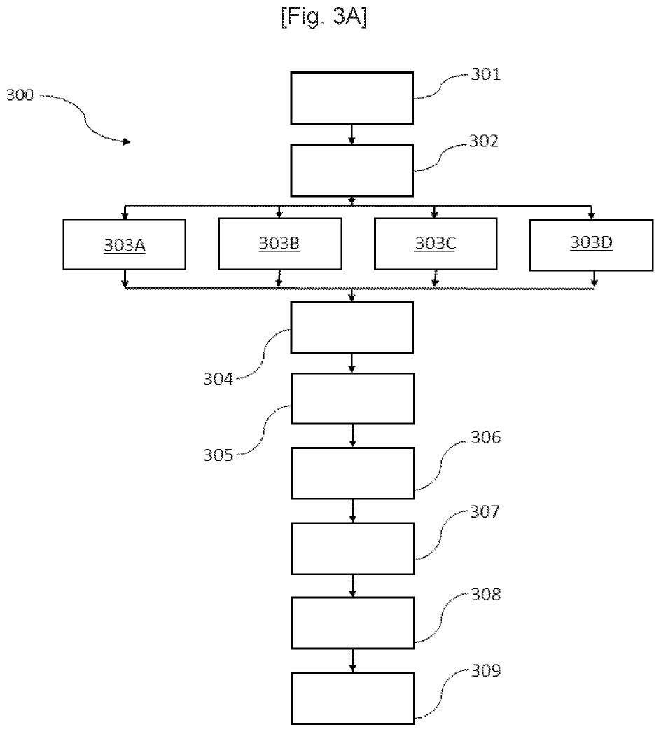

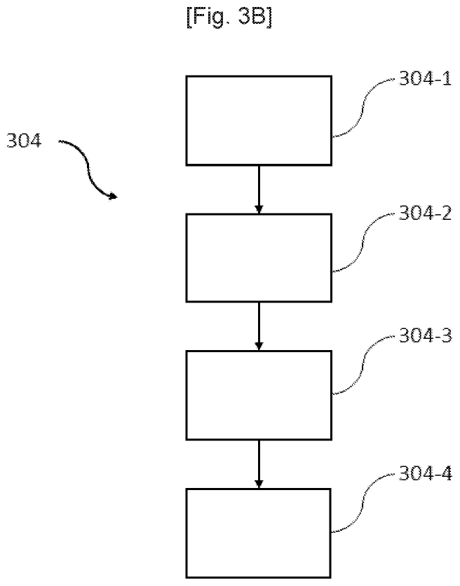

A method 300 represented in FIG. 3A may be used to predict a probability of damage to the tanks of the ship 1 and/or of the stationary floating structure 40.

The method 300 includes first a step 301 in which a predicted geographical position of the LNG transfer operation is obtained. This geographical position can also be entered by a user or acquired automatically by a system on board the ship 1 or the stationary floating structure 40, for example in the form of GPS coordinates.

After step 301 the method 300 proceeds to a step 302 in which meteorological and oceanographic forecasts are obtained for the geographic position obtained in step 301. Forecasts of this kind are for example transmitted by communication means such as radio or satellite by a supplier of meteorological and oceanographic forecasts. The forecasts are obtained for a plurality of periods of time that together cover a predicted duration of the LNG transfer operation, which predicted duration can be entered by a user.

The forecasts for each period of time include at least one swell state. They preferably further include a wind sea state or a current state or a wind state, more preferably a plurality of these states, and even more preferably all these states.

After the step 302 the method 300 further includes the following steps:
a step 303A in which there are extracted from the forecasts obtained in step 302, for each period of time, a direction of the swell (represented in FIG. 2 by the direction of the axis 12), a significant height of the swell, and a peak period of the swell;
where appropriate, a step 303B in which there is/are extracted from the forecasts obtained in step 302, for each period of time, a significant wind sea height and/or a peak wind sea period and/or a wind sea direction (represented in FIG. 2 by the direction of the axis 10);
where appropriate, a step 303C in which there is/are extracted from the forecasts obtained in step 302, for each period of time, a speed of the current and/or a direction of the current (represented in FIG. 2 by the direction of the axis 14);
where appropriate, a step 303D in which there is/are extracted from the forecasts obtained in step 302, for each period of time, a speed of the wind and/or a direction of the wind (represented in FIG. 2 by the direction of the axis 16).

The method 300 thereafter includes the following steps, which are repeated for each of the periods of time:
a step 304 in which the common bearing 99 of the ship 1 and of the stationary floating structure 40 is obtained;
a step 305 in which there is determined at least one forecast level of filling of at least one tank of the ship 1 and/or of the stationary floating structure 40;
a step 306 in which an angle of attack of the swell is determined, that is to say an angle between the common bearing 99 and the direction of the swell (represented in FIG. 2 by the direction of the axis 12);
a step 307 in which there is estimated at least one probability of damage to the tank the forecast filling level of which was determined in step 305, as a function of: the angle of attack of the swell determined in step 306; the significant height of the swell and the peak period of the swell extracted in step 303A; and the at least one forecast level of filling of the tank in question determined in step 305.

Step 305 may be executed in various ways. In one variant one or more forecast levels of filling of the tank are determined from a liquid load transfer scenario defining an evolution of the filling level of said tank as a function of time. A liquid load transfer scenario of this kind may be determined in advance and for example entered by the user before the transfer operation.

A plurality of forecast filling levels of the tank may be determined in step 305, a probability of damage to the tank being estimated in step 307 for each forecast filling level of the tank determined in step 305. In a variant, in step 305 two forecast filling levels of the tank are determined, the two forecast filling levels including a low forecast filling level and a high forecast filling level. In one particular variant the low forecast filling level and the high forecast filling level are forecast filling levels determined in advance: step 305 then consists in merely reading—for example in the database mentioned hereinafter with reference to step 307—the values of the low forecast filling level and of the high forecast filling level. The low forecast filling level and the high forecast filling level may be determined in advance during a preliminary step (not represented in the drawings) consisting in looking, for example by simulation and/or by experiment, for two filling levels of the tank that are the most likely to produce a risk of damage to the tank caused by sloshing.

When a plurality of tanks of the ship 1 and/or of the stationary floating structure 40 are considered, steps 305 and 307 are executed for each of those tanks. The choice may also be made to consider only some of the tanks of the ship 1 and/or of the stationary floating structure 40, for example one or some of the tanks of the ship 1 and/or of the stationary floating structure 40 for which it has been determined by means of a preliminary analysis that they are those the most subject to a risk of damage caused by sloshing.

The step 307 may be executed by consultation of a database established beforehand for the tank concerned of the ship 1 or of the stationary floating structure 40. A database of this kind contains data relating to sloshing as a function of an angle of attack of the swell, of a significant height of the swell, or of a peak period of the swell, and of a current filling level of said tank, the data relating to sloshing being determined by experiment.

The probability of damage is related to a density of probability of encountering a pressure on an internal surface of the tank greater than an internal strength of the tank as a function of the angle of attack of the swell, of the significant height of the swell, of the peak period of the swell and of the filling level of said tank.

The common bearing 99 obtained in step 304 may be defined in advance. In a variant the common bearing 99 may be entered by a user, for each period of time, or even for all the periods of time considered. In an advantageous variant, for each period of time, this common bearing 99 is obtained so as to take into account forces to which the ship 1 and the floating structure 40 are subjected because of the swell state and preferably because of the wind sea state and/or the current state.

FIG. 3B represents an example of this kind of implementation of step 304 in which:
in a first step 304-1 there are calculated the forces to which the ship 1 and the floating structure 40 are subjected because of the swell state and preferably because of the wind sea state and/or the current state and/or the wind state;
in a second step 304-2 there is calculated a resultant of the forces determined in step 304-1;
in a third step 304-3 there is calculated a moment of the resultant determined in step 304-2 about the anchor point 90.

The steps 304-1, 304-2, 304-3 are executed for a plurality of theoretical bearings, that is to say a plurality of possible values of the common bearing 99. For example, steps 304-1, 304-2, 304-3 are executed for common bearing 99 value increments of 5 degrees, 2 degrees or 1 degree. Thereafter, in a step 304-4, a common bearing 99 is selected from said plurality of theoretical bearings that minimizes the absolute value of the moment determined in step 304-3.

After step 307 the method 300 proceeds to a step 308 in which information is supplied to the user as a function of the probabilities of damage estimated in step 307.

This step 308 may simply consist in giving a visual and/or sound alarm to the user if the probability of damage to one of the tanks exceeds a predetermined threshold. In addition to this or instead of this, the information supplied in step 308 may include supplying to the user at least one visual indication of the probabilities of damage estimated in step 307 as a function of some other magnitude.

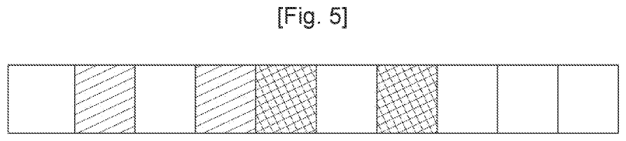

FIG. 5 represents by way of example a visual indication of the probabilities of damage estimated in step 307 as a function of the periods of time to which they relate. In this figure the visual indication comprises a box corresponding to each of the periods of time. An absence of hatching indicates that the probability of damage is zero or below a low threshold. Single hatching indicates that the probability of damage is between a low threshold and a high threshold. Double hatching indicates that the probability of damage is above a high threshold. It is clear that different colors in accordance with a color code or any other representation may be employed instead of different hatching. It is moreover clear that a different number of probability of damage thresholds may be used.

After step 308 the method 300 preferably proceeds to a step 309 of assisting the decision intended to be reduce the probability or probabilities of damage estimated in step 307. This decision assistance step 309 may in particular include supplying to the user:
a proposal to change the common bearing 99, and/or
a proposal to modify at least one parameter of the transfer operation, for example a liquid load transfer flowrate (between the tanks of the ship 1 and/or between the tanks of the stationary floating structure 40 and/or between the tanks of the ship 1 and the tanks of the stationary floating structure 40) and/or a level of filling of the tank or tanks.

Thanks to this step 309 the user is made capable of implementing the necessary measures on the basis of these proposals in order to reduce the risk of damage to the tanks.

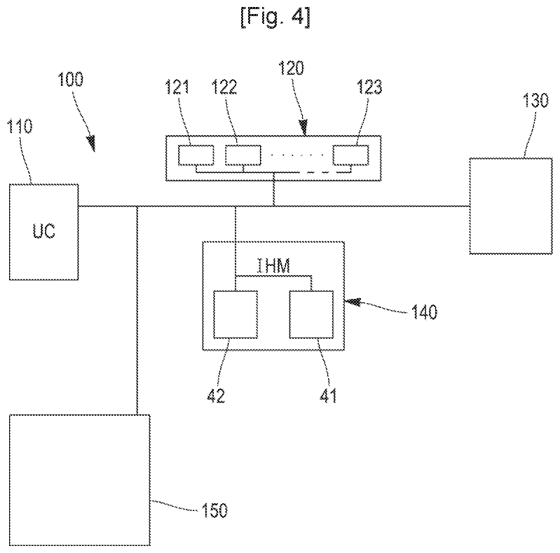

FIG. 4 depicts a sloshing determination device 100 that can be onboard the ship 1. This device 100 includes a central unit 110 configured to execute the various steps of the method 300 to estimate the probability of damage to a tank of the ship 1 and/or of the stationary floating structure 40.

The central unit 110 is connected to a plurality of onboard sensors 120 enabling the various magnitudes indicated hereinabove to be obtained. The sensors 120 therefore include, for example and non-exhaustively, a sensor 121 for the filling level of each tank and other sensors 122, 123 able to supply as their output magnitudes indicating the swell state and preferably the wind sea state and/or the current state and/or the wind state.

The device 100 further includes a human-machine interface 140. This human-machine interface 140 includes a display means 41 enabling an operative on the ship 1 to obtain various kinds of information, for example the probabilities of damage estimated using the steps of the method 300, the information generated in step 308, the decision assistance generated in step 309, the magnitudes obtained by the sensors 120, the load state of the ship or meteorological information.

The human-machine interface 140 further includes an acquisition means 42 enabling the operative to input magnitudes manually into the central unit 110, typically to supply to the central unit 110 data that cannot be obtained by sensors because the ship 1 does not include the necessary sensor or the latter is damaged. For example, in one embodiment the acquisition means 42 enables the operative to enter information on the wind sea state and/or the swell state.

The device 100 includes a database 150. This database 150 contains for example some magnitudes obtained in the laboratory or during measurement campaigns carried out onboard at sea. For example, for a given tank the database 150 may include data relating to sloshing as a function of an angle of attack of the swell, a significant height of the swell, a peak period of the swell and a current filling level of said tank.

The device 100 also includes a communication interface 130 enabling the central unit 110 to communicate with remote devices, for example to obtain meteorological forecasts and data on the position of the ship or other data.

Some elements represented, in particular the central unit 110, may be produced in various forms, in a unitary or distributed manner, by means of hardware and/or software components. Usable hardware components include application-specific integrated circuits (ASIC), field-programmable gate arrays (FPGA) and microprocessors. Software components may be written in various programming languages, for example C, C++, C#, Java (registered trademark) or VHDL. This list is not exhaustive.

In the description hereinabove reference is made to a peak period of the swell, that is to say a period of time between the passage of two successive peaks of the swell. In a variant, instead of and in place of the peak period of the swell the mean period of the swell may be considered, that is to say a period of time between three successive passages of the swell at the mean height of the sea.

Similarly, instead of and in place of the peak wind sea period there may be considered the mean wind sea period, that is to say a period of time between three successive passages of the wind sea at the mean height of the sea.

The principles described hereinabove are equally applicable to a floating structure transporting a liquid load and anchored to an anchor point. Indeed, the liquid load of a floating structure of this kind is also liable to be agitated by the effect of waves, which can also lead to a phenomenon of sloshing that is liable to compromise the integrity of the tank or tanks containing the liquid load.

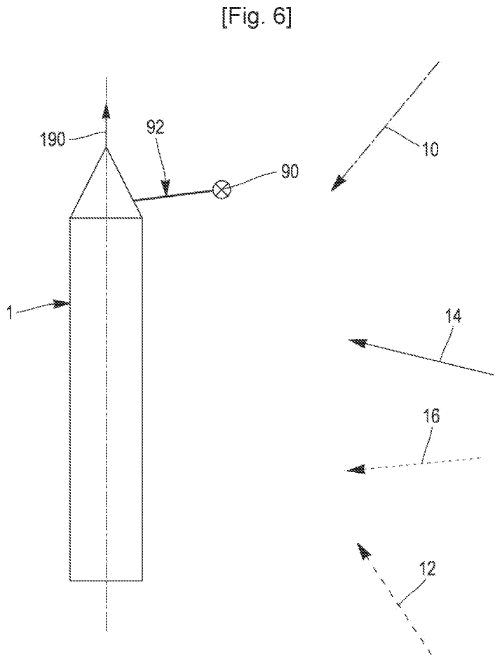

There has therefore been represented in FIG. 6 the ship 1 from FIG. 1 moored by one or more mooring lines 92 to an anchor point 90 relative to the seabed, such as a submarine buoy anchored to the seabed. The ship 1 is free to pivot about the anchor point 90 and can therefore adopt any bearing by pivoting about the anchor point 90. Here the bearing of the ship 1 bears the reference 190.

As described above with reference to FIG. 2, here the ship 1 is also subject to the wind sea excitation represented by the axis 10, to the swell excitation represented by the axis 12, to the current excitation 14 and to the wind excitation 16. The movements of the ship 1 are transmitted to the liquid contained in the tanks 3, 4, 5, 6 which is consequently subjected to sloshing in the tanks 3, 4, 5, 6 producing impacts on the tank walls. If the sloshing exceeds the capacity of the tank walls to absorb or to disperse the sloshing the impacts on the walls of the tanks 3, 4, 5, 6 can damage the walls of the tanks 3, 4, 5, 6. Now it is important to preserve the integrity of the walls of the tanks 3, 4, 5, 6 to preserve the seal and the insulation characteristics of the tanks 3, 4, 5, 6. It is therefore also important here to estimate a probability of damage caused by sloshing in order to prevent such damage.

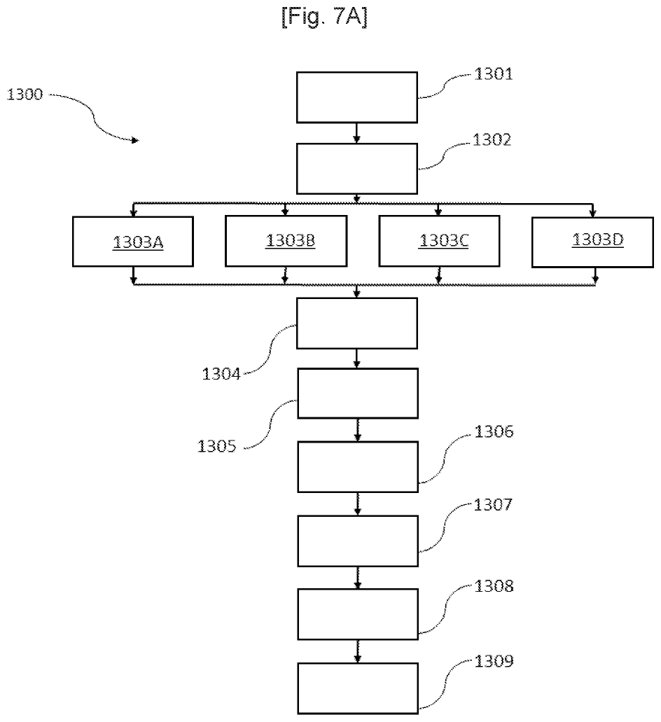

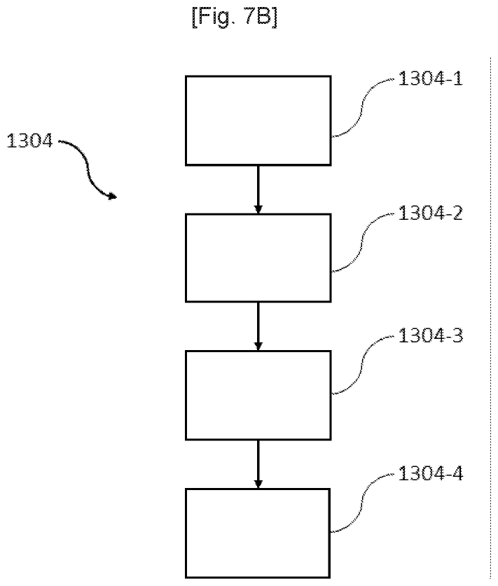

A method 1300 represented in FIG. 7A may be employed to predict a probability of damage to the tanks of the ship 1.

The method 1300 includes first a step 1301 in which a geographical position is obtained of the ship 1 moored to the anchor point 190. This geographical position may be entered by a user or acquired automatically by a system onboard the ship 1, for example in the form of GPS coordinates.

After step 1301 the method 1300 proceeds to a step 1302 in which meteorological and oceanographic forecasts are obtained relative to the geographical position obtained in step 1301. Forecasts of this kind are for example transmitted by communication means such as radio or satellite by a supplier of meteorological and oceanographic forecasts. The forecasts are obtained for a plurality of periods of time that together cover a predicted duration of the LNG transfer operation, which predicted duration can be entered by a user.

The forecasts for each period of time include at least one swell state. They preferably further include a wind sea state or a current state or a wind state, more preferably a plurality of these states, and even more preferably all these states.

After the step 1302 the method 1300 further includes the following steps:
a step 1303A in which there are extracted from the forecasts obtained in step 1302, for each period of time, a direction of the swell (represented in FIG. 6 by the direction of the axis 12), a significant height of the swell, and a peak period of the swell;
where appropriate, a step 13035 in which there is/are extracted from the forecasts obtained in step 1302, for each period of time, a significant wind sea height and/or a peak wind sea period and/or a wind sea direction (represented in FIG. 6 by the direction of the axis 10);
where appropriate, a step 1303C in which there is/are extracted from the forecasts obtained in step 1302, for each period of time, a speed of the current and/or a direction of the current (represented in FIG. 6 by the direction of the axis 14);
where appropriate, a step 1303D in which there is/are extracted from the forecasts obtained in step 1302, for each period of time, a speed of the wind and/or a direction of the wind (represented in FIG. 6 by the direction of the axis 16).

The method 1300 then includes the following steps, which are repeated for each of the time periods:
a step 1304 in which the bearing 190 of the ship 1 is obtained;
a step 1305 in which there is determined at least one forecast filling level for at least one tank of the ship 1;
a step 1306 in which there is determined an angle of attack of the swell, that is to say an angle between the bearing 190 of the ship 1 and the direction of the swell (represented in FIG. 6 by the direction of the axis 12);
a step 1307 in which there is estimated at least one probability of damage to the tank the forecast filling level of which was determined in step 1305, as a function of: the swell angle of attack determined in step 1306: the significant height of the swell and the peak period of the swell extracted in step 1303A; and the at least one forecast filling level of the tank in question determined in step 1305.

If a plurality of the tanks of the ship 1 are considered, steps 1305 and 1307 are executed for each of those tanks. The choice may equally be made to consider only some of the tanks of the ship 1, for example one or some of the tanks of the ship 1 for which it has been determined by an analysis carried out beforehand that they are the most subject to a risk of damage caused by sloshing.

Step 1307 may be executed by consultation of a database established beforehand for the tank concerned of the ship 1. A database of this kind includes data relating to sloshing as a function of an angle of attack of the swell, a significant height of the swell, a peak period of the swell and a current filling level of said tank, the data relating to sloshing being determined by experiment. The probability of damage is related to a density of probability of encountering a pressure on an internal surface of the tank greater than the internal strength of the tank as a function of the angle of attack of the swell, of the significant height of the swell, of the peak period of the swell and of the filling level of said tank.

The bearing 190 obtained in step 1304 may be defined in advance. In a variant the bearing 190 may be entered by a user for each period of time or even for all the periods of time considered. In an advantageous variant, for each period of time, this bearing 190 of the ship is obtained so as to take account of the forces to which the ship 1 is subjected because of the swell state and preferably the wind sea state and/or the current state.

FIG. 7B represents an example of this kind of execution of step 1304 in which:
in a first step 1304-1 there are calculated the forces to which the ship 1 is subjected because of the swell state and preferably because of the wind sea state and/or because of the current state and/or of the wind state;
in a second step 1304-2 there is calculated a resultant of the forces determined in step 1304-1;
in a third step 1304-3 there is calculated a moment of the resultant determined in step 1304-2 about the anchor point 90.

The steps 1304-1, 1304-2, 1304-3 are executed for a plurality of theoretical bearings, that is to say a plurality of possible values of the bearing 190. For example, steps 1304-1, 1304-2, 1304-3 are executed for bearing 190 value increments of 5 degrees, 2 degrees or 1 degree. Thereafter, in a step 1304-4, there is selected from said plurality of theoretical bearings a bearing 190 that minimizes the absolute value of the moment determined in step 1304-3.

After step 1307 the method 1300 proceeds to a step 1308 in which information is supplied to a user as a function of the probabilities of damage estimated in step 1307.

This step 1308 may simply consist in giving a visual and/or sound alarm to the user if the probability of damage to one of the tanks exceeds a predetermined threshold. In addition to or instead of this the information supplied to the user in step 1308 may include at least one visual indication of the probabilities of damage estimated in step 1307 as a function of some other magnitude. This visual indication may be analogous to that described hereinabove with reference to FIG. 5.

After step 1308 the method 1300 preferably proceeds to a step 1309 of assisting the decision intended to reduce the probability or probabilities of damage estimated in step 1307. This step 1309 of assisting the decision may in particular include supplying to the user:
a proposal to change the bearing 190, and/or
a proposal to modify a filling level of at least one of the tanks of the ship 1.

Thanks to this step 1309 the user is made capable of implementing the necessary measures on the basis of these proposals in order to reduce the risk of damage to the tanks.

The various steps of the method 1300 may be executed by the central unit 110 of the device 100 already described hereinabove with reference to FIG. 4.

The above description refers to a peak period of the swell, that is to say a period of time between the passage of two successive peaks of the swell. In a variant, instead of and in place of the peak period of the swell, the mean period of the swell may be considered, that is to say a period of time between three successive passages of the swell at the mean height of the sea.

Likewise, instead of and in place of the peak period of the wind sea the mean period of the wind sea may be considered, that is to say a period time between three successive passages of the wind sea at the mean height of the sea.

Although the invention has been described with reference to particular embodiments it is obvious that it is in no way limited to them and that it encompasses all technical equivalents of the means described and combinations thereof if they fall within the scope of the invention.

Furthermore, it is obvious that a feature or a combination of features described with reference to a method apply equally to a corresponding system and vice versa.

Use of the verb “to include” or “to comprise” or conjugate forms thereof does not exclude the presence of elements or steps other than those stated in a claim.

In the claims any reference sign between parentheses should not be interpreted as a limitation of the claim.

1. A method (300) for estimation of a probability of damage caused by sloshing of a liquid load during an operation to transfer said liquid load from a first floating structure (1) to a second floating structure (40), the first floating structure (1) and the second floating structure (40) being associated with one another during said transfer operation so that the first floating structure (1) and the second floating structure (40) are oriented with a common bearing (99), said method (300) including:
obtaining (301) a forecast geographical position of said transfer operation;
obtaining (302) meteorological and oceanographic forecasts relating to said geographical position for a plurality of periods of time, said periods of time together covering a forecast duration of said transfer operation, said forecasts including, for each period of time, a swell state, in which the state of the swell includes a direction of the swell, a significant height of the swell and a period of the swell;
for each period of time: obtaining (304) the common bearing (99) of the first and second floating structures (1, 40); determining (305) at least one forecast filling level of at least one tank of at least one of said first or second floating structures (1, 40) intended to contain all or part of said liquid load; determining (306) an angle of attack of the swell, which is an angle between said common bearing (99) of the first and second floating structures and the direction of the swell (12); and estimating (307) at least one probability of damage to said at least one tank as a function of the angle of attack of the swell determined in this way, of the significant height of the swell, of the period of the swell and of said at least one forecast filling level of said tank; and
supplying (308) information to a user as a function of said at least one probability of damage estimated in this way.

2. The method (300) as claimed in claim 1 wherein said at least one forecast filling level is determined (305) from a liquid load transfer scenario defining an evolution of the filling level of said tank as a function of time.

3. The method (300) as claimed in claim 1 in which, for each period of time, two forecast filling levels of said tank are determined (305), the two forecast filling levels including a low forecast filling level and a high forecast filling level, and a probability of damage to said tank is estimated (307) for each of the two forecast filling levels.

4. The method (300) as claimed in claim 1 in which said at least one probability of damage is estimated (307) by consultation of a database established beforehand for said tank, said database including data relating to sloshing as a function of an angle of attack of the swell, of a significant height of the swell, of the period of the swell and of a current filling level of said tank, the data relating to sloshing being determined by experiment, and
the probability of damage being related to a density of probability of encountering a pressure on an internal surface of the tank above an internal strength of the tank as a function of the angle of attack of the swell, of the significant height of the swell, of the period of the swell and of the current filling level of said tank.

5. The method (300) as claimed in claim 1 in which said information includes information representing the probability of damage estimated as a function of said periods of time.

6. The method (300) as claimed in claim 1 in which said forecasts further include a wind sea state including a significant wind sea height and/or a wind sea period and/or a wind sea direction (10) and the probability of damage to said at least one tank is further estimated as a function of the wind sea state.

7. The method (300) as claimed in claim 1 in which the first floating structure (1) and the second floating structure (40) are anchored to an anchor point (90) during said transfer operation and, for each period of time, said common bearing (99) of the two floating structures (1, 40) is obtained (304) by:
calculating (304-2, 304-3), for a plurality of theoretical bearings, a resultant of the forces to which the first and second floating structures are subjected as a function of the swell state and of a moment relative to the anchor point (90) of said resultant; and
selecting (304-4) from said plurality of theoretical bearings a common bearing (99) that minimizes the absolute value of the moment relative to the anchor point of said resultant.

8. The method (300) as claimed in claim 6 in which the first floating structure (1) and the second floating structure (40) are anchored to an anchor point (90) during said transfer operation and, for each period of time, said common bearing (99) of the two floating structures (1, 40) is obtained (304) by:
calculating (304-2, 304-3), for a plurality of theoretical bearings, a resultant of the forces to which the first and second floating structures are subjected as a function of the swell state and of a moment relative to the anchor point (90) of said resultant; and
selecting (304-4) from said plurality of theoretical bearings a common bearing (99) that minimizes the absolute value of the moment relative to the anchor point of said resultant; and
in which the resultant of the forces to which the first and second floating structures (1, 40) are subjected is further calculated (304-2) as a function of the wind sea state.

9. The method (300) as claimed in claim 7 in which said forecasts further include a wind state including a speed of the wind and/or a direction of the wind (16) and in which the resultant of the forces to which the first and second floating structures are subjected is further calculated as function of the wind state.

10. The method (300) as claimed in claim 7 in which said forecasts further include a current state including a speed of the current and/or a direction (14) of the current and in which the resultant of the forces to which the first and second floating structures (1, 40) are subjected is further calculated as a function of the current state.

11. The method (300) as claimed in claim 1 in which said information includes information representing the probability of damage estimated as a function of said plurality of theoretical bearings.

12. The method (300) as claimed in claim 1 further including a step (309) of assisting the decision intended to reduce the estimated probability of damage.

13. The method (300) as claimed in claim 12 in which the step (309) of assisting the decision includes supplying to the user:
a proposal to change the common bearing (99), and/or
a proposal to modify at least one parameter of the transfer operation.

14. The method (300) as claimed in claim 1 in which the liquid load is a liquefied gas load, in particular a liquefied petroleum gas load or a liquefied natural gas load.

15. The method (300) as claimed in claim 14 in which the liquid load is a liquefied natural gas load, the first floating structure is a liquefied natural gas carrier ship (1) and the second floating structure is a liquefied natural gas floating storage and regasification unit (40) or a liquefied natural gas floating production unit.

16. A device (100) for estimation of a probability of damage caused by sloshing of a liquid load during an operation to transfer said liquid load from a first floating structure (1) to a second floating structure (40), the first floating structure (1) and the second floating structure (40) being associated with one another during said transfer operation so that the first floating structure and the second floating structure are oriented with a common bearing (99), the device (100) including a processor (110) configured to execute the method (300) as claimed in claim 1.

17. A floating structure (1, 40) including a device (100) as claimed in claim 16.
